(19) United States
(12) Patent Application Publication
(10) Pub. No.: US 2006/0072077 A1
(43) Pub. Date: Apr. 6, 2006

(54) Rear projector

(76) Inventors: Seok-il Yoon, Seo-gu (KR); Sung-gi Kim, Suwon-si (KR); Young-il Kah, Suwon-si (KR)

Correspondence Address: STANZIONE & KIM, LLP, 919 18TH STREET, N.W., SUITE 440, WASHINGTON, DC, 20006, US

(21) Appl. No.: 11/188,718

(22) Filed: Jul. 26, 2005

(30) Foreign Application Priority Data
Oct. 5, 2004 (KR) 2004-79244

(51) Int. Cl. G03B 21/28

(52) U.S. Cl. 353/77

(57) ABSTRACT

A rear projector that can be made slim and compact and can prevent image reversal. The rear projector includes a cathode ray tube to scan light and generate an image, a projection lens unit to magnify and project the image generated by the cathode ray tube, a screen on which the projected image is formed, and a reflection optical system interposed between the projection lens unit and the screen to change a path of projected light. The cathode ray tube and the reflection optical system are arranged such that a raster direction of the cathode ray tube and a direction along which the image is formed on the screen are parallel or substantially parallel to each other.

### CROSS-REFERENCE TO RELATED APPLICATIONS

This application claims priority from Korean Patent Application No. 2004-79244, filed on Oct. 5, 2004, in the Korean Intellectual Property Office, the disclosure of which is incorporated herein in its entirety by reference.

### BACKGROUND OF THE INVENTION

1. Field of the Invention

The present general inventive concept relates to a rear projector, and more particularly, to a rear projector which can be made slim and compact, and can prevent image reversal.

2. Description of the Related Art

In general, projectors provide images by projecting an image generated by an image forming unit onto a screen. Projectors are classified as front projectors or rear projectors according to a method of magnifying and projecting the image generated by the image forming unit. When using a rear projector all of the components thereof including the screen can be placed in a cabinet, therefore rear projectors can be applied to home projection televisions, and the like.

Referring to FIG. 1, a conventional rear projector includes a cabinet 10, a cold cathode ray tube (CRT) 11 installed in the cabinet 10 for generating an image, a projection lens unit 13 for magnifying and projecting an incident image, and a reflecting mirror 15 for reflecting the projected image onto the screen. A screen 17 is installed on a front surface of the cabinet 10 and allows an image projected from the rear of the screen 17 to be formed thereon, such that the image formed on the screen 17 can be viewed at a predetermined wide viewing angle. The image formed on the screen 17 can be viewed outside the cabinet 10. The projection lens unit 13 magnifies and projects the image emitted by the cold CRT 11 to the reflecting mirror 15. The reflecting mirror 15 is installed inside the cabinet 10 to face the screen 17 at an angle. The reflecting mirror 15 reflects the incident image onto the screen 17.

An optical arrangement of the conventional rear projector of FIG. 1 will be explained with reference to FIG. 2. Referring to FIG. 2, a raster direction b₁ of the cold CRT 11 and a direction a₁ along which the image is formed on the screen 17 form an angle of approximately 90° therebetween. The angle between the directions a₁ and b₁ may be varied within a range of 90°±45° depending on the angle at which the reflecting mirror 15 is positioned. A raster is a set of scan lines of the cold CRT 11, which are used to form the image.

Since the reflecting mirror 15 is employed and the cold CRT 11 is disposed at a lower side of the cabinet 10, the rear projector can be made slim. However, since the raster direction b₁ and the image direction a₁ form approximately 90° therebetween, a height of the cabinet 10, which is comprised of a height of the screen 17 and a height of the cold CRT 11, increases accordingly.

FIG. 3 is a schematic view illustrating an optical arrangement of another conventional rear projector, which does not include a reflecting mirror. Referring to FIG. 3, a cold CRT 21, a projection lens unit 23, and a screen 27 are aligned inside a cabinet 20. A raster direction b₂ of the cold CRT 21 and a direction a₂ along which an image is formed on the screen 27 form an angle of 180° therebetween.

Since a height of the cabinet 20 can be set according to only a height of the screen 27, a height of the rear projector of FIG. 3 is decreased from the height of the rear projector of FIG. 2. However, since the cold CRT 21 is disposed behind the screen 27, a total thickness of the rear projector is increased. Further, an image reversal may occur when the raster direction b₂ and the direction a₂ along which the image is formed on the screen 27 are reversed.

### SUMMARY OF THE INVENTION

The present general inventive concept provides a rear projector, which can be made slim and compact by optimizing a height and a thickness of a cabinet and can prevent image reversal.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a rear projector comprising a cathode ray tube to scan light and generate an image, a projection lens unit to magnify and project the image generated by the cathode ray tube, a screen on which the projected image is formed, and a reflection optical system interposed between the projection lens unit and the screen to change a path of projected light, wherein the cathode ray tube and the reflection optical system are arranged such that a raster direction of the cathode ray tube and a direction along which the image is formed on the screen are parallel or substantially parallel to each other.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic sectional view illustrating a conventional rear projector;

FIG. 2 is a schematic view illustrating an optical arrangement of the conventional rear projector of FIG. 1;

FIG. 3 is a schematic view illustrating an optical arrangement of another conventional rear projector;

FIG. 4 is a schematic sectional view illustrating a rear projector according to an embodiment of the present general inventive concept; and

FIG. 5 is a schematic view illustrating an optical arrangement of the rear projector of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

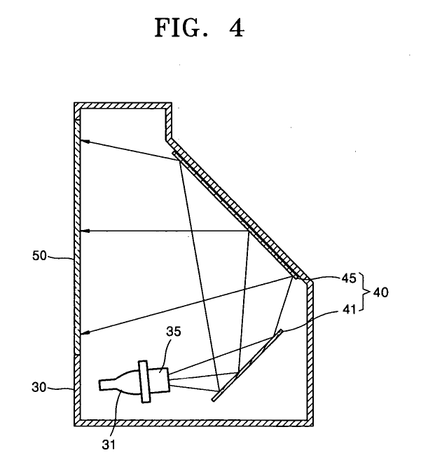

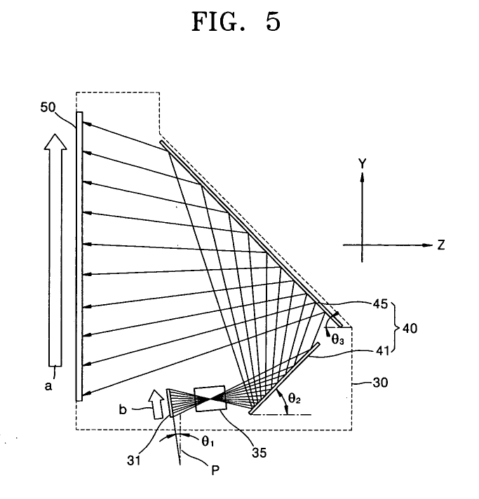

Referring to FIGS. 4 and 5, a rear projector according to an embodiment of the present general inventive concept is structured such that all components thereof are installed inside a cabinet 30. The rear projector includes a cathode ray tube (CRT) 31 to scan light and generate an image, a projection lens unit 35 to magnify and project the image generated by the CRT 31, a screen 50 on which the magnified and projected image is formed, and a reflection optical system 40 interposed between the projection lens unit 35 and the screen 50 to change a path of projected light. For illustration purposes only a light-emitting surface of the CRT 31 is illustrated in FIG. 5.

The screen 50 is installed on a front surface of the cabinet 30, and allows the image projected from a rear side thereof to be formed thereon along a direction indicated by arrow “a,” such that the image is viewed at a predetermined wide viewing angle. The screen 50 may include a combination of a lenticular lens having a predetermined gain (e.g., a gain of about 4.5), and a Fresnel lens having a predetermined focal length (e.g., a focal length of about 670 mm). Since the configuration of the screen 50 should be known to those skilled in the art, a detailed explanation thereof will not be provided.

The CRT 31 scans an electron beam to generate the image and emits the generated image to the projection lens unit 35. The CRT 31 may be a cold CRT. In this case, a coupler (not shown) is filled with a coolant to reduce heat generated in the cold CRT, and a lens system (not shown) to adjust an angle at which the image is emitted are disposed on a front surface of the cold CRT. A raster is composed of scan lines of the CRT 31, which are used to form the image, and a raster direction is a vertical or substantially vertical direction indicated by arrow “b” of FIG. 5.

In order to make the direction “a” along which the image is formed on the screen 50 and the raster direction “b” of the CRT 31 parallel or substantially parallel to each other, the CRT 31 is disposed in the cabinet 30. Here, it is assumed that the directions “a” and “b” are substantially parallel to each other when an angle θ₁ between the direction “a” and the raster direction “b” of the CRT 31 ranges between 0 to 5°, and the directions “a” and “b” are parallel to each other when the angle θ₁ is 0°. For illustration purposes, FIG. 5 includes a virtual surface P parallel to the image formed on the screen 50 located at a raster point of the CRT 31. The angle θ₁ is illustrated as an angle between the raster direction “b” and the virtual surface P

The projection lens unit 35 is disposed in an optical path between the CRT 31 and the reflection optical system 40 to magnify and project an incident image. Referring to FIG. 5, the projection lens unit 35 first focuses the incident image, and magnifies the incident image since the screen 50 is positioned outside a focal point of the projection lens unit 35. Accordingly, the image emitted from the CRT 31 is reversed after passing through the projection lens unit 35. The projection lens unit 35 may have a predetermined focal length (e.g., a focal length of 68.06 mm), which may be determined by considering a total size of the cabinet 30.

The reflection optical system 40 includes at least two reflecting mirrors, and guides the image magnified and projected by the projection lens unit 35 such that the image is formed on the screen 50. The reflection optical system 40 also reverses the image reversed by the. projection lens unit 35. The reflection optical system 40 guides the incident image to the screen 50 when the CRT 31 and the screen 50 are arranged such that the direction “a” along which the image is formed and the raster direction “b” are parallel or substantially parallel to each other.

As illustrated in FIGS. 4 and 5, the reflection optical system 40 includes a first reflecting mirror 41 to reflect an incident image, and a second reflecting mirror 45 to reflect the image reflected by the first reflecting mirror 41 onto the screen 50.

In an optical arrangement of the first and second reflecting mirrors 41 and 45, the second reflecting mirror 45 may be disposed above the first reflecting mirror 41, and the first and second reflecting mirrors 41 and 45 may be angled in opposite directions.

FIG. 5 includes a Y-Z axis coordinate system. The Y-axis extends in a height direction of the rear projector, and the Z-axis extends along a depth/thickness direction of the rear projector. The Z-axis and the first reflecting mirror 41 form an angle of θ₂ therebetween and the Z-axis and the second reflecting mirror 45 form an angle of θ₃ therebetween. The angles θ₂ and θ₃ of the first and second reflecting mirrors 41 and 45 may satisfy the following Equation 1.

$${θ}_{2} + {θ}_{3} - \frac{{θ}_{1}}{2} = 90 [ Deg . ] \qquad ( 1 )$$

Since the first reflecting mirror 41 is close to the projection lens unit 35, the first reflecting mirror 41 may be smaller in size than the second reflecting mirror 45. Accordingly, the CRT 31 and the projection lens unit 35 can be easily arranged in front of the first reflecting mirror 41.

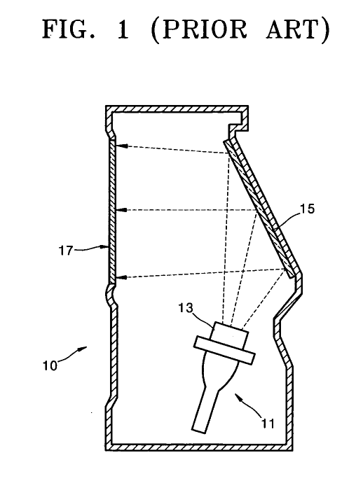

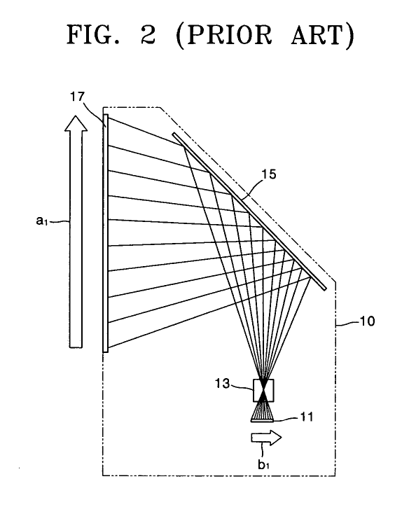

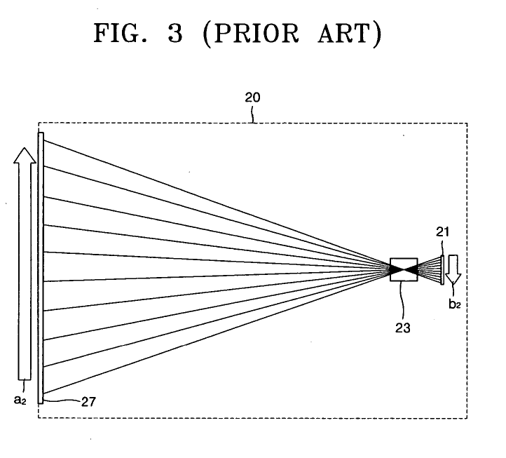

According to the arrangement of the first and second reflecting mirrors 41 and 45, the raster direction “b” of the CRT 31 and the direction “a” along which the image is formed on the screen 50 are the same. Furthermore, since the CRT 31 and the projection lens unit 35 can be disposed under a space between the screen 50 and the second reflecting mirror 45, the thickness, that is, the depth, of the cabinet 30 can be reduced as compared with a conventional rear projector illustrated FIG. 3. The height of the cabinet 30 can also be reduced as compared with a conventional rear projector illustrated in FIGS. 1 and 2.

While the reflection optical system 40 of FIGS. 4 and 5 includes the first and second reflecting mirrors 41 and 45, the reflection optical system of the present general inventive concept can alternatively include two or more reflecting mirrors.

As described above, a rear projector according to the present general inventive concept can emit an image generated by a CRT onto a screen 50 without image reversal by optimizing an optical arrangement of the CRT and a reflection optical system. Moreover, the rear projector can be made slim and compact by reducing a height and a thickness of the cabinet 30.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A rear projector, comprising:
a cathode ray tube to scan light and generate an image;
a projection lens unit to magnify and project the image generated by the cathode ray tube;
a screen on which the projected image is formed; and
a reflection optical system interposed between the projection lens unit and the screen to change a path of the magnified and projected image,
wherein the cathode ray tube and the reflection optical system are arranged such that a raster direction of the cathode ray tube and a direction along which the image is formed on the screen are parallel or substantially parallel to each other.

2. The rear projector of claim 1, wherein when a raster of the cathode ray tube and the image formed on the screen are drawn at the same point, the raster direction of the cathode ray tube and the direction along which the image is formed on the screen form an angle of between 0 to 5°.

3. The rear projector of claim 2, wherein the reflection optical system comprises:
a first reflecting mirror disposed at a first angle with respect to a first direction of the rear projector to face the projection lens unit and to reflect an incident image; and
a second reflecting mirror disposed at a second angle with respect to the first direction of the rear projector and between the first reflecting mirror and the screen to reflect the image reflected by the first reflecting mirror to the screen.

4. The rear projector of claim 3, wherein the first reflecting mirror and the second reflecting mirror are angled in opposite directions with respect to the first direction of the rear projector.

5. The rear projector of claim 4, wherein the first direction of the rear projector corresponds with a depthwise direction of the rear projector.

6. The rear projector of claim 3, wherein the cathode ray tube and the projection lens unit are disposed under a space between the screen and the second reflecting mirror.

7. The rear projector of claim 1, wherein the reflection optical system comprises:
a first reflecting mirror disposed at a first angle with respect to a first direction of the rear projector to face the projection lens unit to reflect an incident image; and
a second reflecting mirror disposed at a second angle with respect to the first direction of the rear projector and between the first reflecting mirror and the screen to reflect the image reflected by the first reflecting mirror to the screen.

8. The rear projector of claim 7, wherein the first reflecting mirror and the second reflecting mirror are angled in opposite directions with respect to the first direction of the rear projector.

9. The rear projector of claim 7, wherein the cathode ray tube and the projection lens unit are disposed under a space between the screen and the second reflecting mirror.

10. The rear projector of claim 7, wherein the second reflecting mirror is disposed above the first reflecting mirror.

11. The rear projector of claim 7, wherein the first reflecting mirror is smaller than the second reflecting mirror and is positioned closer to the cathode ray tube than the second reflecting mirror.

12. The rear projector of claim 1, wherein the projection lens unit reverses the image generated by the cathode ray tube.

13. The rear projector of claim 12, wherein the reflection optical system reverses the image projected by the projection lens unit.

14. The rear projector of claim 1, wherein the screen is positioned outside a focal length of the projection lens unit.

15. The rear projector of claim 1, wherein the reflection optical system comprises more than two reflecting mirrors.

16. A rear projector, comprising:
a housing;
a screen disposed at a front surface of the housing;
an image generator disposed adjacent to a bottom of the screen near the front surface of the housing;
a projection lens unit disposed adjacent to the image generator to magnify and to project the generated image toward a rear surface of the housing; and
a reflection unit disposed at the rear surface of the housing to reflect the projected image onto the screen.

17. The rear projector of claim 16, wherein the image generator comprises a cathode ray tube having a raster direction that is parallel to a direction along which the reflected image is formed on the screen.

18. The rear projector of claim 16, wherein the reflection unit comprises:
a first reflector disposed adjacent to the projection lens unit angled toward a top surface of the housing; and
a second reflector disposed at the rear surface of the housing angled toward a bottom surface of the housing and having a larger size than the first reflector.

19. The rear projector of claim 16, wherein the image generator is positioned in the housing above a level of a bottom edge of the screen.

20. A rear projector, comprising:
a housing;
a screen disposed at a front surface of the housing;
an image generator disposed within the housing to create and project an image; and
a reflection unit disposed near a rear surface of the housing to reflect the projected image onto the screen such that an image with scan lines having a raster direction at a predetermined angle is reflected onto the screen along which the image is formed at a direction substantially parallel to the raster direction.

21. A projector to form an image on a screen from a rear side thereof, comprising:
a cathode ray tube dispose adjacent to the screen to scan an image away from the rear side of the screen at an angle θ₁ with respect to a height axis of the projector;
a projection unit to receive the image from the cathode ray tube, to magnify the image, and to project the image away from the cathode ray tube toward a rear of the projector;
a first reflector disposed at an angle θ₂ with respect to a depth axis of the projector to receive the projected image and to reflect the image along the height axis of the projector; and
a second reflector disposed adjacent to the first reflector and at an angle θ₃ with respect to the depth axis of the projector to reflect the projected image on the rear side of the screen, wherein the angle θ₁, angle θ₂, and angle θ₃ are defined by: θ₂+θ₃−θ₁/2=90 degrees.
